(19) United States
(12) Patent Application Publication
(10) Pub. No.: US 2016/0356079 A1
(43) Pub. Date: Dec. 8, 2016

(54) PRIVACY SCREEN WITH INDEXED ROTATABLE FOOT

(71) Applicant: Teknion Limited, Toronto (CA)

(72) Inventors: Christian Gauvin, Levis (CA); Frédéric Marier, Levis (CA)

(21) Appl. No.: 14/731,069

(22) Filed: Jun. 4, 2015

(51) Int. Cl. E06B 9/24

(52) U.S. Cl. CPC E06B 9/24

(57) ABSTRACT

A privacy screen has a frame, a shaft rotatably connected to and extending downwardly from a bottom frame portion, a foot secured to a distal end of the shaft, and an engagement member secured to the bottom frame portion. The engagement member has a pair of spaced apart resilient convex shoulders. The shaft has an engagement portion located above the foot and between the shoulders, at least four indents being defined in a circumference of the shaft. Each of the pair of shoulders are adapted to be received within one of a first pair of the four indents. Rotation of the foot forces the pair of shoulders out of engagement with the first pair of indents and rotates the shaft until a subsequent pair of the four indents engages the pair of shoulders, thereby causing indexed movement of the foot.

### FIELD

This disclosure relates generally to a privacy screen, and more specifically to a privacy screen with a foot capable of indexed rotation.

### INTRODUCTION

Modular and reconfigurable privacy screens may be useful for certain applications, such as an office environment, in order to visually and/or physically separate portions of a room.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In accordance with a broad aspect, there is provided a privacy screen comprising: a frame comprising a bottom frame portion, the frame enclosing an area; a screen secured to the frame and covering the area; a shaft rotatably connected to the bottom frame portion, the shaft extending downwardly from the bottom frame portion; a foot secured to a distal end of the shaft; and an engagement member secured to the bottom frame portion, the engagement member comprising a pair of spaced apart resilient convex shoulders; wherein the shaft comprises an engagement portion located above the foot and between the shoulders, the engagement portion of the shaft having a circumference, wherein at least four indents are defined in the circumference; wherein each of the pair of shoulders are adapted to be received within one of a first pair of the four indents of the engagement portion of the shaft; and wherein rotation of the foot forces the pair of shoulders out of engagement with the first pair of indents and rotates the shaft until a subsequent pair of the four indents engages the pair of shoulders, thereby causing indexed movement of the foot.

In some embodiments, the circumference between the indents has a convex shape, wherein the convex shape of the circumference urges the shoulders to engage only the indents.

In some embodiments, a center of each indent is located at 90 degree intervals along the circumference, thereby causing the foot to rotate in an indexed fashion in 90 degree intervals.

In some embodiments, the foot has an elongate shape defining opposing longitudinal surfaces; wherein when rotated to a first 90 degree interval, the foot is in an aligned position in which one of the longitudinal surfaces is coplanar with the bottom frame portion; and when rotated to a subsequent 90 degree interval, the foot is in a transverse position in which the longitudinal surface is perpendicular to the bottom frame portion.

In some embodiments, the engagement member is made of a resiliently flexible material.

In some embodiments, the foot and the shaft are integrally formed.

In some embodiments, the engagement member comprises a pair of connector bores, each connector bore for receiving a fastener therethrough for securing the engagement member to the bottom frame portion.

In some embodiments, an outer convex surface of each shoulder is made of a rigid material, and wherein at least a portion of the engagement member located between the outer convex surface and the connector bores is made of a resiliently flexible material.

In some embodiments, the engagement member comprises a pair of opposing engagement members, each of the opposing engagement members having one of the pair of shoulders.

In some embodiments, each of the opposing engagement members comprises a connector bore, each connector bore for receiving a fastener therethrough for securing that opposing engagement member to the bottom frame portion.

In some embodiments, an outer convex surface of each shoulder is made of a rigid material, and wherein at least a portion of each opposing engagement member located between the outer convex surface and the connector bore is made of a resiliently flexible material.

In some embodiments, the shaft comprises a bore through a longitudinal axis of the shaft, and wherein the shaft is rotatably connected to the bottom frame portion by a fastener received in the bore.

In some embodiments, an upper surface of the foot is substantially flush with an underside of the bottom frame portion.

In some embodiments, a width of the foot between the opposing longitudinal surfaces is substantially equal to a width of the bottom frame portion.

In some embodiments, a length of the foot along the opposing longitudinal surfaces is at least 10 times a width of the foot between the opposing longitudinal surfaces.

In some embodiments, the screen is translucent.

In some embodiments, the area enclosed by the frame is rectangular.

In some embodiments, the foot comprises one or more levelers.

It will be appreciated by a person skilled in the art that a method or apparatus disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a perspective view of a plurality of privacy screens positioned in an office environment;

FIG. 2 is a perspective view of a privacy screen according to one embodiment;

FIG. 3A is a perspective view of a lower corner of the privacy screen of FIG. 2 with a foot in a transverse position;

FIG. 3B is the perspective view of FIG. 3A with the foot in another position;

FIG. 3C is the perspective view of FIG. 3A with the foot in an aligned position;

FIG. 4 is an exploded view of the frame and feet of the privacy screen of FIG. 2;

FIG. 5 is an exploded view of a privacy screen foot according to one embodiment;

FIG. 6 is a partially exploded view of the foot of FIG. 4 and a lower portion of a privacy screen frame;

FIG. 7 is a close-up perspective view of the underside of the privacy screen of FIG. 2 with the foot in a transverse position;

FIG. 8 is a top schematic view of an engagement member and a shaft secured to a foot according to one embodiment;

FIG. 9 is the top schematic view of FIG. 8 with the shaft rotated approximately 45°.

FIG. 10 a top view of an engagement member according to another embodiment; and

FIG. 11 is an exploded view of the engagement member of FIG. 10 and a privacy screen foot according to one embodiment.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

While the apparatus and methods disclosed herein are described specifically in relation to a rectangular privacy screen, it will be appreciated that the apparatus and methods may alternatively be used with other types of privacy screens.

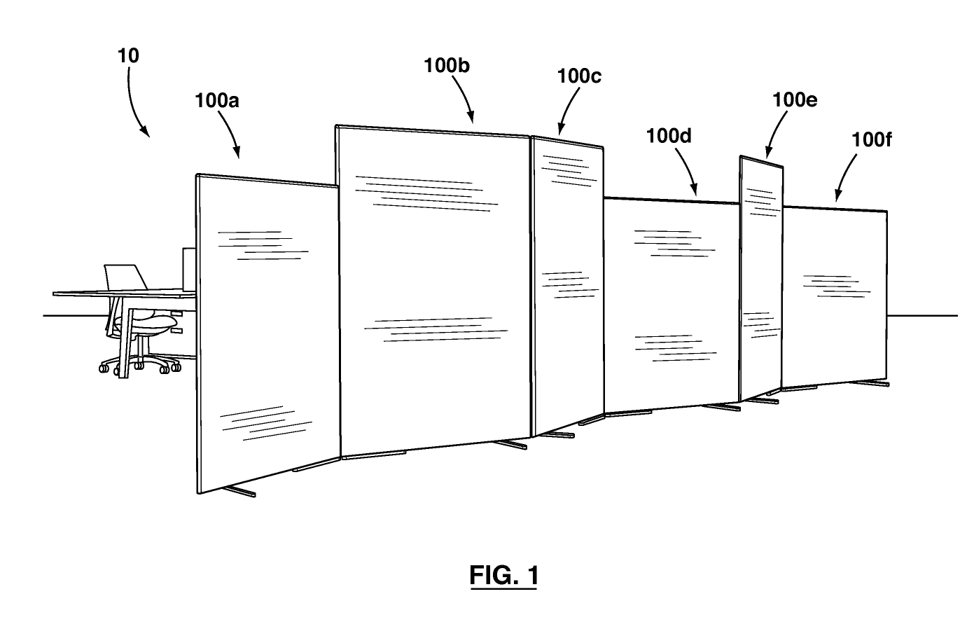

FIG. 1 illustrates a plurality of freestanding privacy screens 100a-f positioned in an office environment 10. Privacy screens 100a-f visually, acoustically, and/or physically divide different portions of the environment 10. For example, privacy screens 100a-f may be used to provide space division and/or a measure of privacy within or between a group of workstations, or in a common area (e.g. a lobby).

In some embodiments, privacy screens 100a-f may be adapted to allow adjacent privacy screens (e.g. screens 100a and 100b) to be releasably coupled to each other using any suitable means, such as interlocking connectors, hook and loop fasteners, magnets, or the like. It will be appreciated that privacy screens 100 may alternatively be placed in abutting relation without being coupled to each other, or used individually.

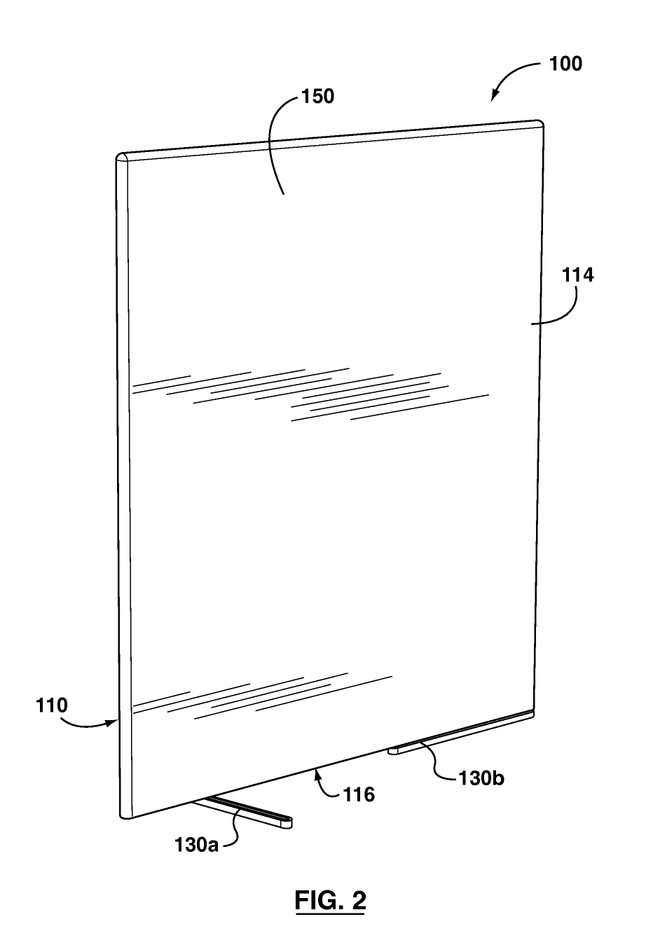

Turning to FIG. 2, a privacy screen 100 has a frame 110 and a screen 150 secured to frame 110. Screen 150 may be constructed from any suitable material, such as a textile, a fabric metal or plastic mesh, or the like. Screen 150 may be opaque or translucent. While embodiments of privacy screen 100 illustrated herein are rectangular or square, it will be appreciated that frame 110 may be provided in other shapes.

A pair of feet 130a,b are connected to the bottom frame portion 112 of frame 110 for supporting the privacy screen. Feet 130a-b are rotatably connected to bottom frame portion 112, and can be individually rotated to a desired orientation. For example, in the illustrated embodiment, foot 130a has been rotated to be perpendicular to frame 110, while foot 130b has been rotated to be parallel or co-planar to frame 110.

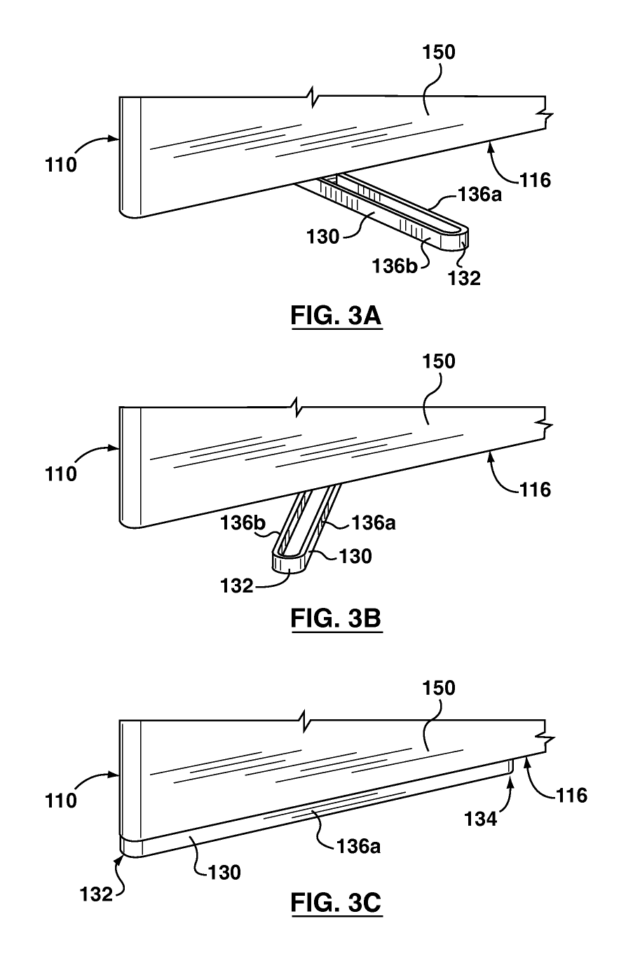

Further examples of the rotation of foot 130 are illustrated in FIGS. 3A-3C. In FIG. 3A, foot 130 is substantially perpendicular to frame 110, with a first end 132 of foot 130 extending and providing a stable base for privacy screen 100. This may be characterized as a transverse position, in which longitudinal surfaces 136a,b of foot 130 are perpendicular to bottom frame portion 112.

In FIG. 3B, foot 130 has been rotated such that longitudinal surfaces 136a,b form an angle of approximately 135° with frame 110.

In FIG. 3C, foot 130 is substantially parallel (or co-planar) to frame 110, with first end 132 and a second end 134 of foot 130 aligned with bottom frame portion 112. This may be characterized as an aligned position, in which longitudinal surfaces 136a,b of foot 130 are coplanar with bottom frame portion 112. It will be appreciated that while in the illustrated embodiment foot 130 is substantially flush with frame 110 when in the aligned position (i.e. there is little or no space between an upper surface of foot 130 and bottom frame portion 112), in alternative embodiments a noticeable gap may be present between foot 130 and bottom frame portion 112 when foot 130 is in an aligned position with frame 110.

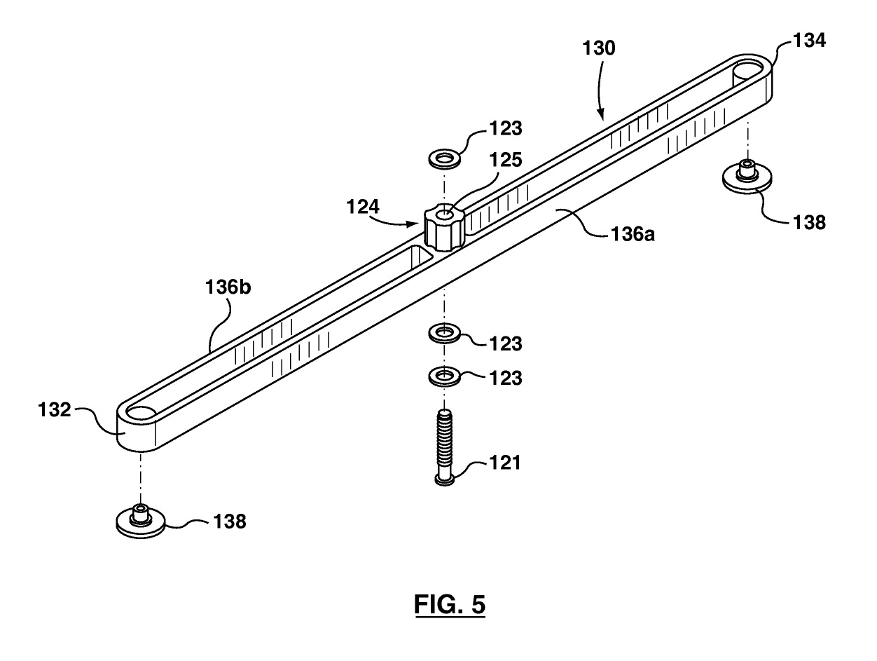

As shown in FIG. 5, ends 132, 134 of foot 130 may each have a leveler 138. Leveler 138 may be rotated or otherwise adjusted to provide a desired amount of space between the underside of foot 130 and an underside of the leveler 138, to allow the feet to provide a stable base for privacy screen 110 on an uneven surface.

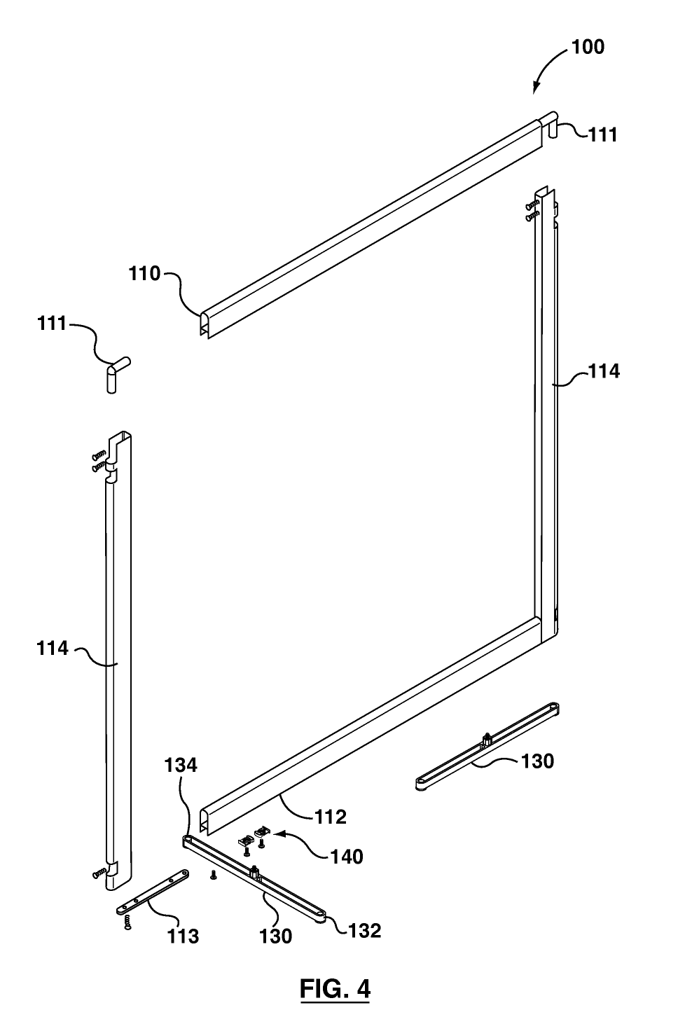

FIG. 4 illustrates a partially exploded view of frame 110 and feet 130. Frame 110 has a top frame portion 116, two side frame portions 114, and bottom frame portion 112. In the illustrated embodiment, the frame portions are secured to each other by inserting L-members 111 and straight members 113 into complementary recesses in the ends of adjoining frame portions, and securing the members to their respective frame portions using mechanical fasteners. It will be appreciated that frame 110 may be assembled using any suitable connection method.

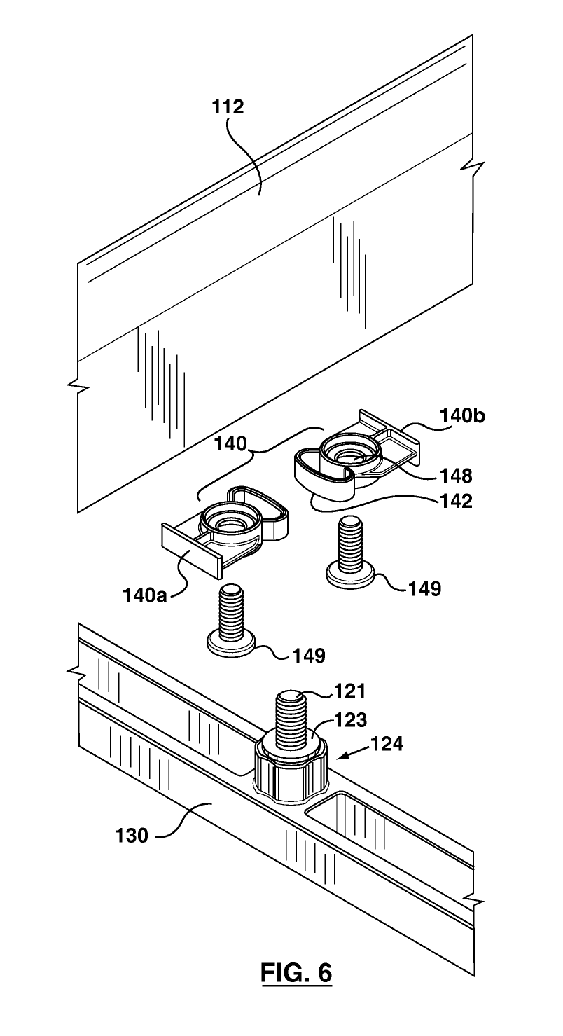

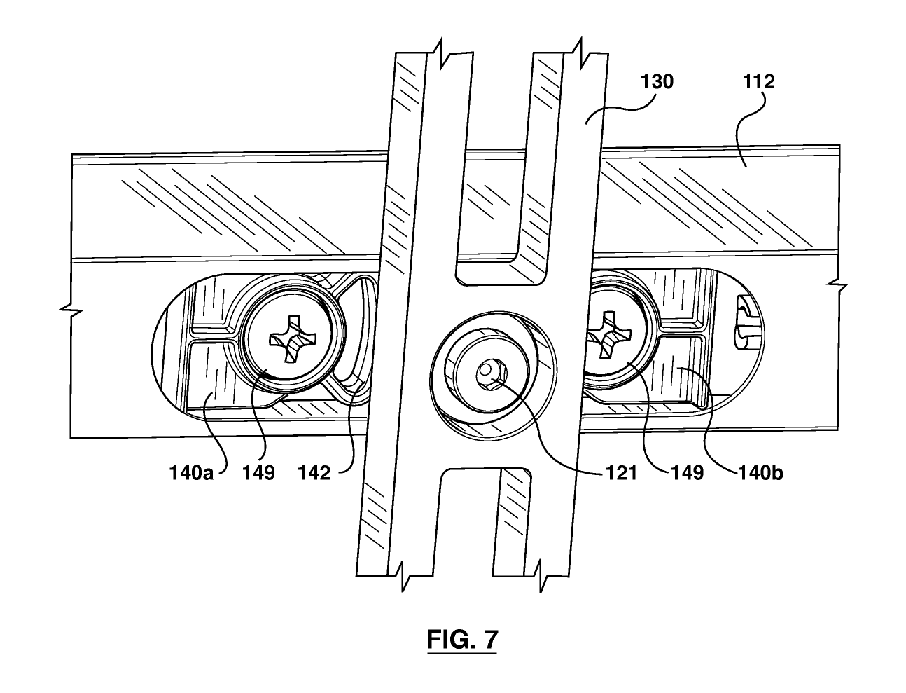

Feet 130 are connected to the underside of bottom frame portion 112. As shown in FIGS. 5 and 6, each foot 130 may have a shaft 124 having a bore 125 therethrough for receiving a fastener 121. Fastener 121 may be inserted into bore 125 from the underside of foot 130, and secured to the underside of bottom frame portion 112. For example, the end of fastener 121 inserted through bore 125 may be threaded, and secured in a complementary nut or threaded bore (not shown) in the underside of bottom frame portion 116. One or more washers 123 may be provided to facilitate rotation of foot 130 about fastener 121 once fastener 121 is secured to bottom frame portion 112.

Preferably, shaft 124 is integrally formed with foot 130, although it will be appreciated that in alternative embodiments a separate shaft 124 may be secured to foot 130.

As illustrated in FIGS. 6 and 7, an engagement member 140 is also secured to the underside of bottom frame portion 112. Engagement member 140 has a pair of convex shoulders 142, and foot 130 is connected to bottom frame portion 112 so that an engagement portion of shaft 124 is positioned between shoulders 142.

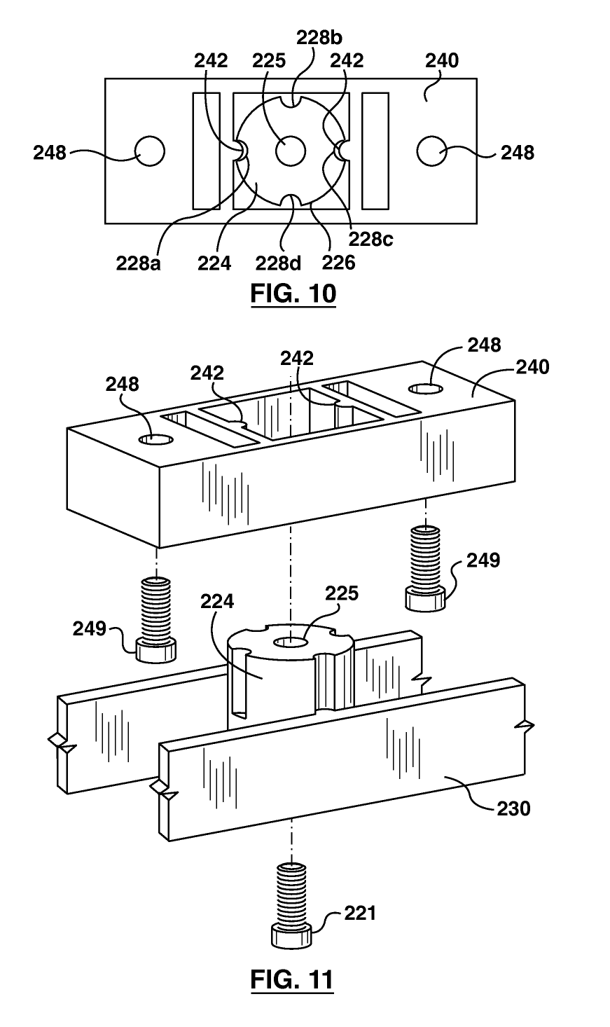

In the embodiment illustrated in FIGS. 6-9, engagement member 140 comprises a pair of opposing engagement members 140a,b, and each of the opposing engagement members has one of the convex shoulders 142. Alternatively, engagement member 140 may be a unitary engagement member. An example of a unitary engagement member 240 is shown in FIGS. 10 and 11. Components similar to those in engagement member 140 have been similarly numbered, and will not be described further.

Returning to FIGS. 6 and 7, engagement member 140 is secured to bottom frame portion 112 by inserting mechanical fasteners, such as screws 149 through fastener bores 148 and into the underside of bottom frame portion 112. It will be appreciated that engagement member 140 may alternatively be secured to the underside of bottom frame portion 112 using any suitable arrangement. For example, engagement member 140 may have one or more projections extending upwardly from the upper surface of engagement member 140, for receipt in corresponding recesses on the underside of bottom frame portion 112. Alternatively, or additionally, an adhesive may be used to secure engagement member 140 to bottom frame portion 112.

Engagement member 140 is preferably made from a flexible, resilient material, such as polypropylene and/or other plastics, metal, and the like. In some embodiments, engagement member 140 is made from more than one material, or from different materials having differing properties. For example, in some embodiments shoulders 142 may be rigid (e.g. made from a rigid material), and a portion of engagement member 140 located between the shoulders 142 and connector bores 148 is made of a resiliently flexible material.

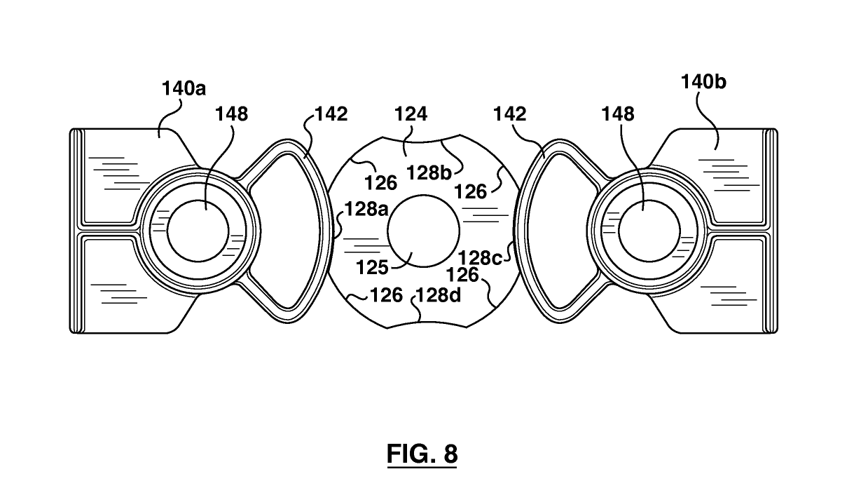

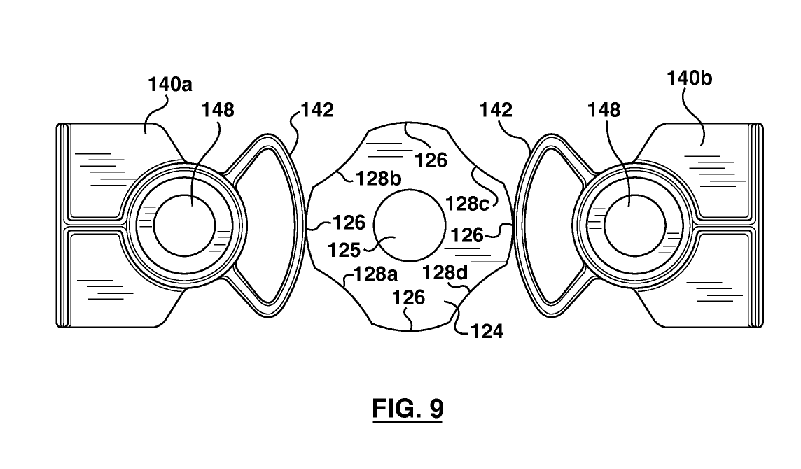

The indexed movement of foot 130 will now be described with reference to FIGS. 8 and 9. Turning to FIG. 8, an engagement portion of shaft 124 (i.e. the portion of shaft 124 positioned between shoulders 142 of engagement member 140) has a circumference 126, and four concave indents 128a-d defined in the circumference 126. In the illustrated position, shoulders 142 are received within (e.g. engaged with) a first pair of indents 128a and 128c. In this position, shoulders 142 and indents 128a, 128c cooperate to resist rotation of shaft 124 relative to engagement member 140, and thereby resist rotation of foot 130 relative to privacy screen 100.

However, as engagement member 140 is made from a resilient material, if sufficient torque is applied to shaft 124 (e.g. by turning foot 130), convex shoulders 142 and/or other portions of engagement member 140 will yield and be forced out of indents 128a, 128c, as shown in FIG. 9. In other words, shoulders 142 and indents 128a, 128c cooperate to resist rotation of shaft 124 relative to engagement member 140.

When shoulders 142 and indents 128a, 128c are no longer engaged, shaft 124 (and thus foot 130) may be rotated relatively freely. Preferably, the torque required to rotate shaft 124 (and thus foot 130) when shoulders 142 are not engaged with indents 128a, 128c (e.g. when shoulders 142 are in contact with outer circumference 126 of shaft 124) is less than the torque required to force shoulders 142 out of engagement with indents 128a, 128c. Also, where circumference 126 is convex, the resilience of shoulders 142 and/or of engagement member 140 may urge the shoulders to engage only the indents 128.

With reference to FIGS. 3A-C, shaft 124 is preferably secured to foot 130 so that shoulders 142 are aligned with a first pair of indents 128a, 128c when foot 130 is in a transverse position relative to privacy screen 100, and so that shoulders 142 are aligned with a second pair of indents 128b, 128d when foot 130 is in an aligned position relative to privacy screen 100.

While shaft 124 is shown with four equally spaced indents 128a-d, providing indexing at 90 degree intervals, it will be appreciated that more indents 128 may be provided to provide additional indexing intervals. For example, a shaft with six evenly spaced indents 128 would provide indexing at 60 degree intervals.

As used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A privacy screen comprising:
a frame comprising a bottom frame portion, the frame enclosing an area;
a screen secured to the frame and covering the area;
a shaft rotatably connected to the bottom frame portion, the shaft extending downwardly from the bottom frame portion;
a foot secured to a distal end of the shaft; and
first and second opposing engagement members secured to the bottom frame portion, the first engagement member comprising a first resilient convex shoulder, and the second engagement member comprising a second resilient convex shoulder;
wherein the shaft comprises an engagement portion located above the foot and between the shoulders, the engagement portion of the shaft having a circumference, wherein at least four indents are defined in the circumference;
wherein the foot is configured to rotate between:
a first indexed position where the first shoulder is received within a first of the at least four indents of the engagement portion of the shaft, and the second shoulder is received within a second of the at least four indents; and
a second indexed position where the first shoulder is received within a third of the at least four indents, and the second shoulder is received within a fourth of the at least four indents; and
wherein rotation of the foot from the first indexed position towards the second indexed position moves the first shoulder out of the first indent and the second shoulder out of the second indent, and rotates the shaft until the first shoulder is received in the third indent and the second shoulder is received in the fourth indent, thereby causing indexed movement of the foot.

2. The privacy screen of claim 1, wherein the circumference between the indents has a convex shape, wherein the convex shape of the circumference urges the shoulders to engage the indents.

3. The privacy screen of claim 1, wherein a center of each indent is located at 90 degree intervals along the circumference, thereby causing the foot to rotate in an indexed fashion in 90 degree intervals.

4. The privacy screen of claim 3, wherein the foot has an elongate shape defining opposing longitudinal surfaces; wherein when rotated to a first 90 degree interval, the foot is in an aligned position in which one of the longitudinal surfaces is coplanar with the bottom frame portion; and when rotated to a subsequent 90 degree interval, the foot is in a transverse position in which the longitudinal surface is perpendicular to the bottom frame portion.

5. The privacy screen of claim 1, wherein the first and second engagement members are made of a resiliently flexible material.

6. The privacy screen of claim 1, wherein the foot and the shaft are integrally formed.

7. (canceled)

8. (canceled)

9. (canceled)

10. The privacy screen of claim 1, wherein each of the first and second engagement members comprises a connector bore, each connector bore for receiving a fastener therethrough for securing that opposing engagement member to the bottom frame portion.

11. The privacy screen of claim 10, wherein at least a portion of the first engagement member located between an outer convex surface of the first shoulder and the connector bore is made of a resiliently flexible material, and wherein the outer convex surface of the first shoulder is more rigid than the portion of the first opposing engagement member located between the outer convex surface of the first shoulder and the connector bore.

12. The privacy screen of claim 1, wherein the shaft comprises a bore through a longitudinal axis of the shaft, and wherein the shaft is rotatably connected to the bottom frame portion by a fastener received in the bore.

13. The privacy screen of claim 1, wherein an upper surface of the foot is substantially flush with an underside of the bottom frame portion.

14. The privacy screen of claim 4, wherein a width of the foot between the opposing longitudinal surfaces is substantially equal to a width of the bottom frame portion.

15. The privacy screen of claim 4, wherein a length of the foot along the opposing longitudinal surfaces is at least 10 times a width of the foot between the opposing longitudinal surfaces.

16. The privacy screen of claim 1, wherein the screen is translucent.

17. The privacy screen of claim 1, wherein the area enclosed by the frame is rectangular.

18. The privacy screen of claim 1, wherein the foot comprises one or more levelers.
